(19) United States
(12) Patent Application Publication
(10) Pub. No.: US 2018/0059276 A1
(43) Pub. Date: Mar. 1, 2018

(54) System and method for focusing seismic images

(71) Applicant: Mark Alvin Roberts, Plano, TX (US)

(72) Inventor: Mark Alvin Roberts, Plano, TX (US)

(73) Assignee: Waveseis LLC, Plano, TX (US)

(21) Appl. No.: 15/247,514

(22) Filed: Aug. 25, 2016

(51) Int. Cl. G01V 1/36

(52) U.S. Cl. CPC G01V 1/362; G01V 2210/512; G01V 2210/57

(57) ABSTRACT

A system or a method for seismic imaging, comprising: selecting an input seismic dataset that samples a subsurface region of interest, migrating said seismic dataset to generate a set of partial images using a processor, generating a set of aligned partial images by focusing said partial images using shifts generated on Vector Offset Gathers as an intermediate step, stacking said partial images to generate an improved image of the subsurface.

### BACKGROUND OF THE INVENTION

Seismic data is commonly used to generate an understanding of the earth's crust. During the seismic acquisition process, seismic energy is sent into the earth and the returning signal is recorded as the seismic data. There are many different seismic source types such as explosives, airguns, vibrators, and background noise. There are also different receiver types such as hydrophones, geophones and accelerometers. Both sources and receivers can be deployed in many different ways depending on the objectives of the survey. For example: on the surface, towed beneath the surface of the water, buried, placed at or beneath the ocean floor, placed in boreholes. An illustration of the seismic acquisition process is shown in FIG. 1. A region of interest, 100, is interrogated by a streamer vessel, 110, towing a plurality of air-gun sources, 120, and an array of streamers, 130. Each streamer, 140, is a cable containing many hydrophone receivers, 150, which are used to record the earth's response to the seismic air-gun source. Each streamer cable is typically 6-8 km long and the array of streamers often comprises of around 10 streamers, approximately 100 m apart. Typically the ship moves forward about 37.5 m between each source firing. Often two source arrays are used for efficiency purposes. The direction of travel of the vessel is called the inline direction and the orthogonal direction is called the crossline direction. For 3D acquisition, where an image of a volume of the earth is required, the ship will typically sail many parallel lines at a regular separation (typically this might be 75 m).

Seismic data can be analyzed in different ways to extract complementary information about the earth (e.g. Yilmaz, 2001). Modern seismic processing starts with loading the recorded data onto a computer system. The seismic data typically is processed in a flow that may include the following steps: noise attenuation, model building, imaging, interpretation. Noise attenuation might include applying computer algorithms to attenuate noise from shipping. Often migration algorithms assume that the data only contains primary reflections (seismic events that are only reflected once in the earth). Due to the primary only approximation, the noise attenuation step often includes computer algorithms that aim to attenuate waves that have been reflected more than once. Model building involves constructing a model of the earth. For seismic migration purposes the earth model contains the speed of propagation of the seismic waves, although the earth model can also contain other parameters such as seismic attenuation. The speed at which the seismic waves travel is important as this is used in the imaging step to position the seismic reflections at the correct location in the earth. Seismic velocities can also be useful for estimating such things as lithology and pore pressure models. Models of seismic velocity can be estimated from seismic data in a number of ways (e.g. Dix, 1955; Symes, 2008). Using the model of seismic velocities and the seismic data after noise attenuation, migration algorithms can be used to generate a seismic image (Etgen et al., 2009). Once an image has been constructed, it is typically displayed on a computer monitor or printed so that it can be interpreted to help understand the structure and other properties of the subsurface of the earth.

The concept of using the misalignment of different data that all image the same point in the sub-surface has existed for many years (e.g. Dix, 1955). Recently different depth migration imaging approaches have been used to improve on this technique. They use the misalignment of either images from different data, such as surface offsets, or a decomposition of the image, such as sub-surface angle or offset (Jones, 2010). Compensating for the residual misalignment of image-gathers such as sub-surface angle or offset can also be used to improve the image quality (Hinkley et al, 2004).

Migration algorithms generally make approximations as to how the seismic waves propagate in the earth, such as ray tracing or beam migration. More accurate imaging algorithms such as Reverse Time Migration (RTM), based on the full two-way wave-equation or Wave-Extrapolation Migration (WEM), based on the one-way wave-equation have recently become popular (Etgen et al., 2009).

In cases where the migration earth model is not accurate, there will be residual misalignment of different image contributions leading to a degradation of the image. Recently the alignment of the image contribution from individual shots has been used to improve seismic image quality (Albertin et al, 2014; Etgen et al, 2014). The number of shots used to generate an image is typically orders of magnitude higher than the number of angles in angle gathers or in either surface or subsurface offsets gathers. The greater decomposition from using individual shots allows for the potential of greater precision and therefore higher image quality. However, alignment methods based on angle-gathers or offset-gathers often use constraints in the angle-domain or offset-domain to allow greater constraints on alignment, preventing the misalignment of different events (a process called cycle skipping) and are therefore more robust.

Jiao et al 2014, presented a method for alignment of partial images based vector offset gathers (VOG), where the offset was defined as being between the source location and the image location (called vector image partitions by Jiao et al 2014). VOG typically have a higher signal to noise ratio than those of individual shots due to the effect of partial stacking. By regularizing the shifts in the vector offset domain, cycle skipping can easily be mitigated effectively handling large errors. The method of aligning VOG typically lacks the precision associated with the alignment of individual shots.

### SUMMARY OF THE INVENTION

A number of embodiments using vector offset and shot alignment for focusing seismic images related to a subsurface region of the earth are presented. According to one implementation, a method for seismic imaging, comprising: selecting an input seismic dataset that samples a subsurface region of interest; migrating said seismic dataset to generate a set of partial images using a processor; generating a set of aligned partial images by focusing said partial images using shifts generated on Vector Offset Gathers (VOG) as an intermediate step; stacking said partial images to generate an improved image of the subsurface, whereby an improved understanding of said subsurface region of interest is achieved. This method has many possible advantages such as compensating for inaccuracies in the earth model and generating improved seismic images.

According to another implementation, a computational system comprising of one or more processors and a set of instructions that when executed will perform the following: loading an input seismic dataset that samples a subsurface region of interest; migrating said seismic dataset to generate a set of partial images using a processor; generating a set of aligned partial images by focusing said partial images using shifts generated on VOG as an intermediate step; stacking said partial images to generate an improved image of the subsurface, whereby an improved understanding of said subsurface region of interest is achieved.

Optionally, the following additional embodiments are included: when the partial images are the migration output of a single seismic source array and a plurality of seismic receivers; when said migrating is performed using a numerical approximation to the two way wave equation (also referred to as RTM); when said migrating is performed using wave extrapolation in depth (also referred to as WEM); when said shifts are computed on time-shift gathers; when said shifts are vertical spatial shifts; when said shifts are spatial shifts perpendicular to the image dip; when said stacking also includes a weighting step; when said alignment is performed iteratively using the improved output image as an updated target image for the alignment process.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a diagram of an exemplary seismic acquisition.

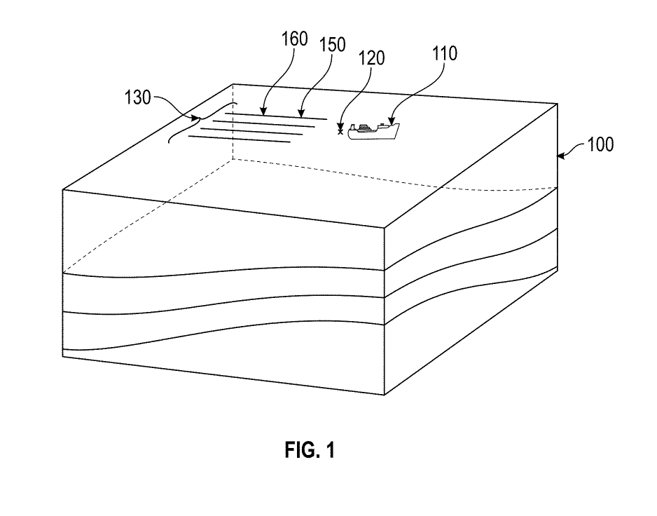

FIG. 2 is a flow chart of an exemplary method for focusing seismic images.

FIG. 3 is a diagram illustrating an earth model used to generate data used as an example, FIG. 3(a) displays the acoustic wave-speed model and FIG. 3(b) displays the reflectivity model.

FIG. 4 is a diagram of an exemplary image generated from a single seismic source.

FIG. 5 is a diagram of a stacked seismic image when using an incorrect earth model.

FIG. 6 is a diagram of vector offset gathers plotted at a distance of 5 km.

FIG. 7 is a flow chart of an exemplary method for computing shifts to align vector offset gathers.

FIG. 8 is a diagram of vector offset shift gathers plotted at a distance of 5 km.

FIG. 9 is a diagram of vector offset gathers plotted at a distance of 5 km after shifts have been applied.

FIG. 10 is a diagram of a stacked seismic image after VOG alignment when using an incorrect earth model.

FIG. 11 is a flow chart of an exemplary method for computing shifts to align shot image gathers.

FIG. 12 is a diagram of a stacked seismic image after VOG and shot alignment when using an incorrect earth model.

FIG. 13 is a diagram of a stacked seismic image after shot alignment when using an incorrect earth model.

FIG. 14 is a graph illustrating the frequency content of different alignment methods.

FIG. 15 is a diagram of an exemplary computational system for performing seismic processing.

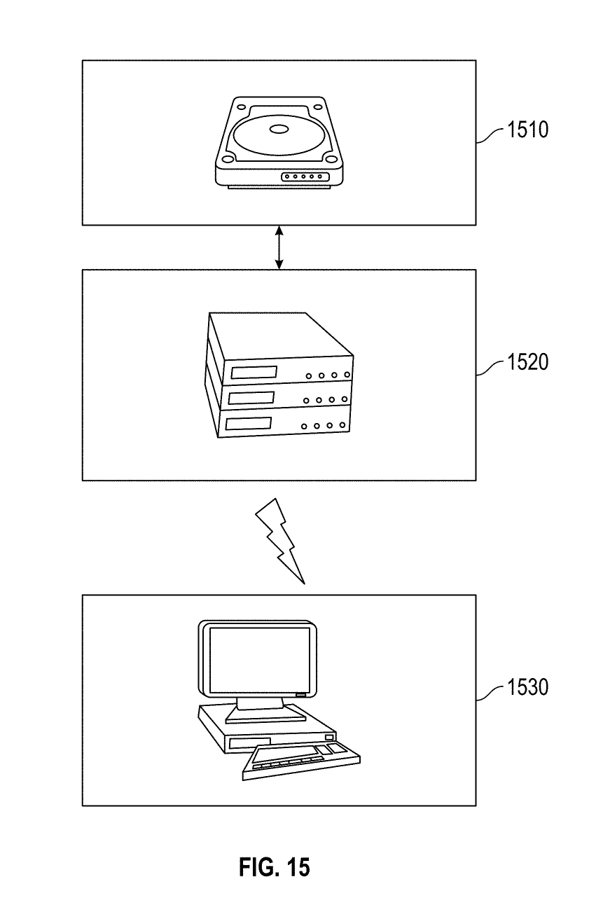

### DETAILED DESCRIPTION

Reference will now be made to the exemplary embodiments illustrated in the drawings and specific language will be used herein to describe the same. It will nevertheless be understood that no limitation of the scope of the invention is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

In embodiments of the invention, selected seismic data that sample a subsurface region of interest are migrated using a received earth model in such a way as to generate partial images and Vector Offset Gathers (VOG). The images are then aligned before stacking to improve the final image, using in part shifts computed on the VOG.

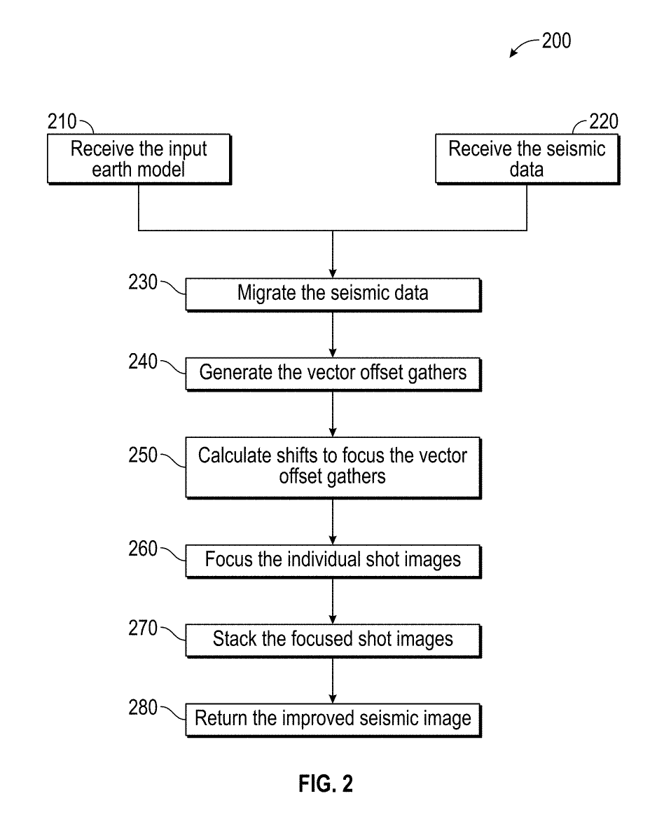

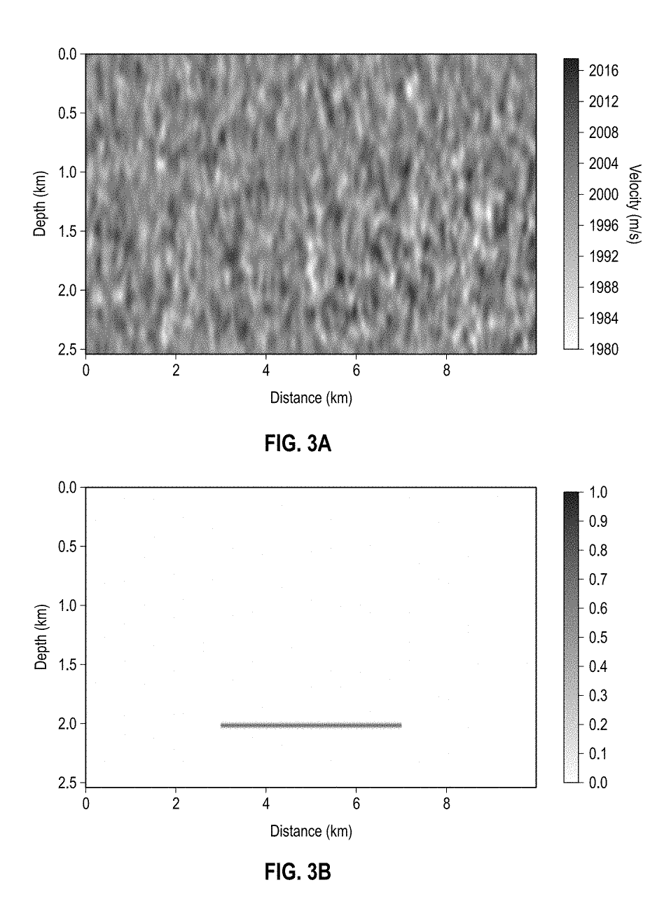

Workflow 200 in FIG. 2 describes an embodiment of the invention. To illustrate this workflow a simple synthetic example is shown. Using the acoustic wave-speed model shown in FIG. 3 (a) and the reflectivity model shown in FIG. 3 (b) seismic data representing a number of shot gathers were modeled using acoustic finite-difference modeling (Dablain, 1986) and demigration (Wong et al, 2015). A total of 96 shots were modeled at a 100 m separation starting 200 m from the left hand side of the model. Each shot was modeled with a point source at 20 m depth using a Ricker wavelet with a dominant frequency of 12.5 Hz. The pressure wavefield was recorded at 20 m depth by a static array of 484 receivers spaced at 20 m and starting at 80 m from the left hand side. An absorbing boundary condition was used on all sides (Liu et al, 2010).

In step 210, an earth model is provided. Typically this earth model may come from a priori information such as well logs or from tomography using the seismic dataset. This earth model is used to migrate the seismic data. The earth model might be an array containing estimates of the acoustic wave speed within the region of interest—for instance the region might be the surface area covered by the seismic survey and the depth down to include any target reservoirs and associated geological structures (typically 10 km or so). Depending on the geology and objects, the earth model by be anisotropic, such as Vertical Transverse Isotropic (VTI), or may be elastic or visco-elastic in which case the earth model would contain more parameters. For the synthetic example, the input earth model was a constant velocity model, with a constant wave-speed of 1850 m/s.

In step 220, the seismic data is provided. Typically this will contain the recorded seismic signal along with meta-data such as the position of the source and receiver associated with that data. Often some preprocessing will have been performed in a prior workflow to attenuate noise etc.

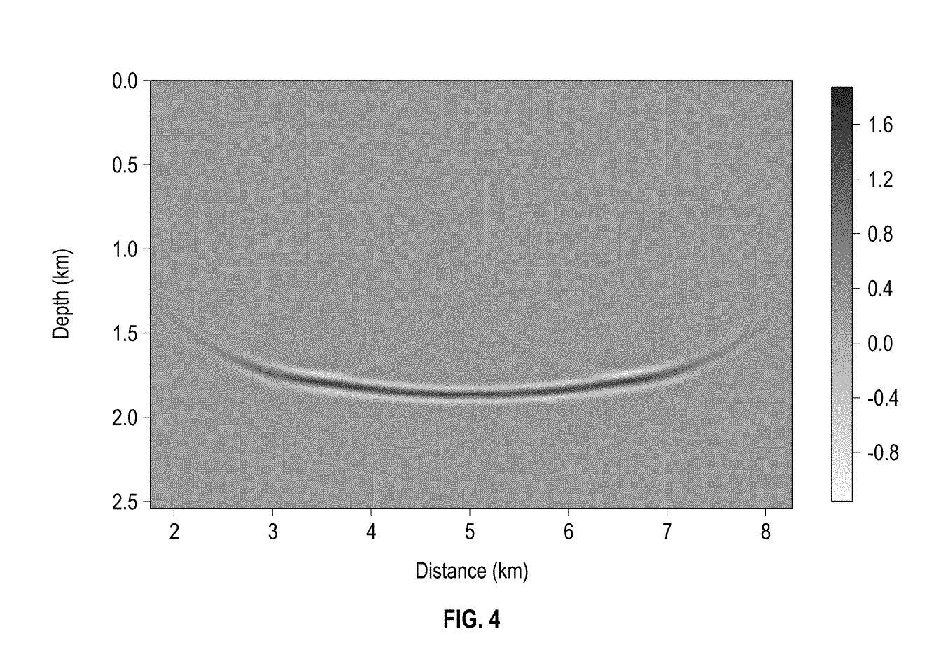

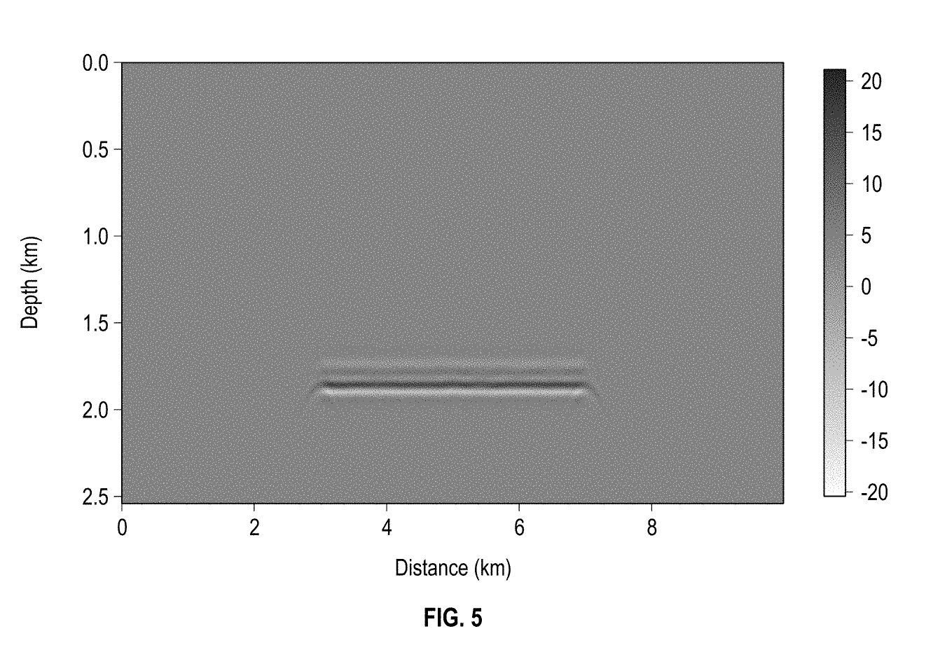

In step 230, the seismic data is migrated using the provided earth model. In this embodiment Reverse Time Migration (RTM) is used to migrate seismic data (Baysal et al, 1983; McMechan, 1983; Whitmore, 1983, Farmer et al, 2009). Instead of stacking the output from each shot as they are processed, the image contribution due to each modeled seismic source wavefield is stored. Typically each seismic source might represent a single air-gun, a collection of air guns that form an array or a “super-shot” formed by combing the data acquired by several separate sources (often where the sources are at similar geographic positions, e.g. Morton et al (2008)). Due to the reciprocity theorem, processing traces that are associated with a common receiver might also be used as a seismic source for computational efficiency reasons (Howie et al, 2008). An example of a single shot output is shown in FIG. 4 for the 48^{th} shot. As the migration velocity model is slower than the correct model, the reflector is not flat and is not correctly positioned but is a little shallower and curved upwards. In FIG. 5, the stack (sum) of the single shot images is shown. The reflector has an extra peak (high amplitude event) above the primary peak due to poor focusing and some slight variations can be seen across the reflector due to the high wavenumber components in the original earth model used to generate the data.

In step 230, VOG are formed. In this embodiment, the vector offset (v) will be defined as,

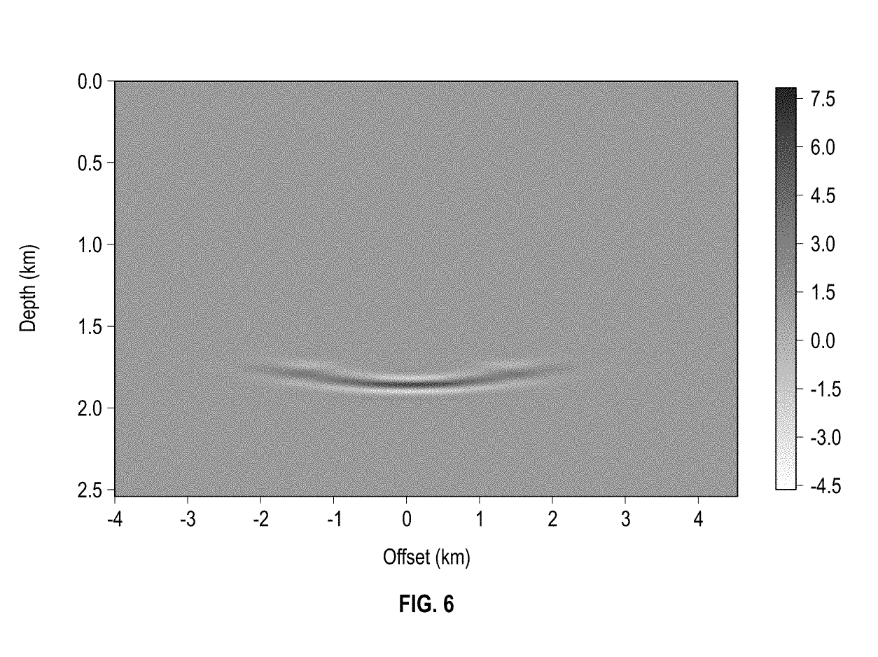

v=O(xₛ−xᵢ) (1)

where xₛ is the source location (taken to be the center of the source array if an array is used) and xᵢ is the image location. O is an operator that acts on the resulting vector; often this will be to take the components in the horizontal plane. Alternative embodiments could possibly take the inline or radial components for example. As the example used here is 2D rather than the more general 3D the resulting vector offset is one-dimensional (inline distance). However, in other embodiments the vector offset could also contain two or more dimensions (typically a user might include the crossline dimension for wide-azimuth surveys for example). The user specifies the parameters used for the VOG. In the examples here, the VOG have the same spatial extent and sampling as the acoustic wave-speed earth model used for migration. A total of 17 vector offset bins are used with the first bin being centered at v=−4000 m, with subsequent bins spaced at 500 m. Typically the array containing the vector offset gathers will be initialized by setting all values in the array to zero. For each image, corresponding to a source at xₛ the vector offset is computed for each location in the image xᵢ. Once the vector offset has been computed the values in the nearest bins are incremented using a linear weight based on the distance from the nearest two bin centers. With the parameters used here for an image at v=−3900, the value would be added to the bin centered at −4000 with a weight of (1.−(−3900+4000)/500)=0.8 and to the bin centered at −3500 with a weight of (4000−3900)/500=0.2. The VOG for the center point in the model (x=5000 m) are shown in FIG. 6. As expected, due to the low migration velocity there is an upward curve to the gather. Other embodiments might use different strategies for forming VOG such as binning the image contribution into the nearest bin or use of alternative interpolation methods.

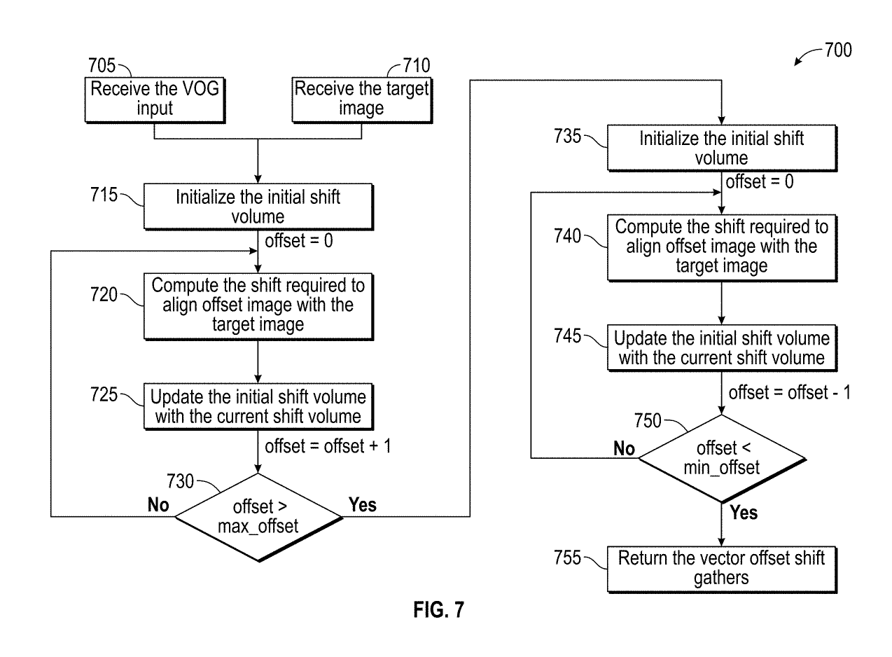

In step 240, shifts are computed to align the images of each VOG. Many strategies exist for flattening gathers, in this specific embodiment a near to far alignment strategy is used as shown in workflow 700 in FIG. 7. In step 705, the VOG are provided for the workflow and a target image is provided in step 710. In this embodiment the target image is the stack over offsets of the VOG and the alignment is performed by maximizing the sum of the image corresponding to a given vector offset and the target image. The maximization is performed by using a local conjugate gradient method (Press et al, 1987) with a preconditioning smoothing regularization (Fomel et al., 2003). Many other strategies exist for aligning images and would be considered as alternate embodiments.

Different methods could be used for aligning the images. A vertical shift could be performed or a time-shift if a time-shift image condition had been used. Velocity errors typically result in time-shifts that result in a shift perpendicular to the reflector dip. However, using a time-shift image condition results in increased computational cost as well as network and storage requirements over a zero-lag cross correlation image condition. In this embodiment the shift shall refer to a shift that is perpendicular to the image dip and computed in the Fourier domain. After performing a 3D Fourier transform to the shot image, each point in the Fourier domain now represents information about events dipping in a unique direction determined by the wavenumber components, k. The shifted image, Iₛ, is computed by:

Iₛ(k)=I(k)exp(sgn(k_{z})2pi∥k∥s) (2)

where: sgn(k_{z}) is the sign of the wavenumber in the vertical direction, s is the spatial shift, exp is the natural exponential function, pi is the mathematical constant for the ratio of
a circle's circumference to its diameter and ∥k∥ is the absolute value (or length) of the wavenumber.

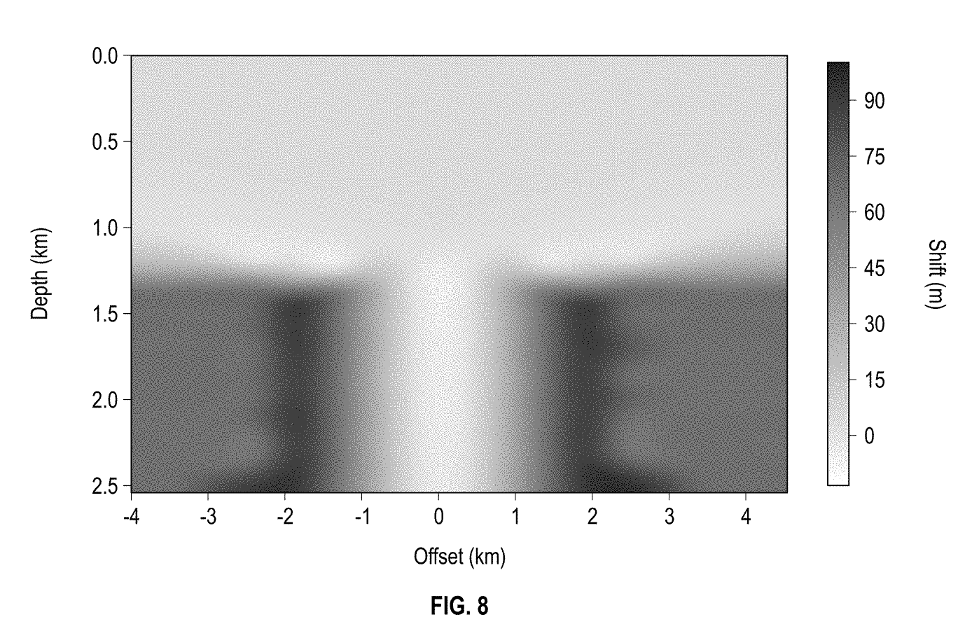

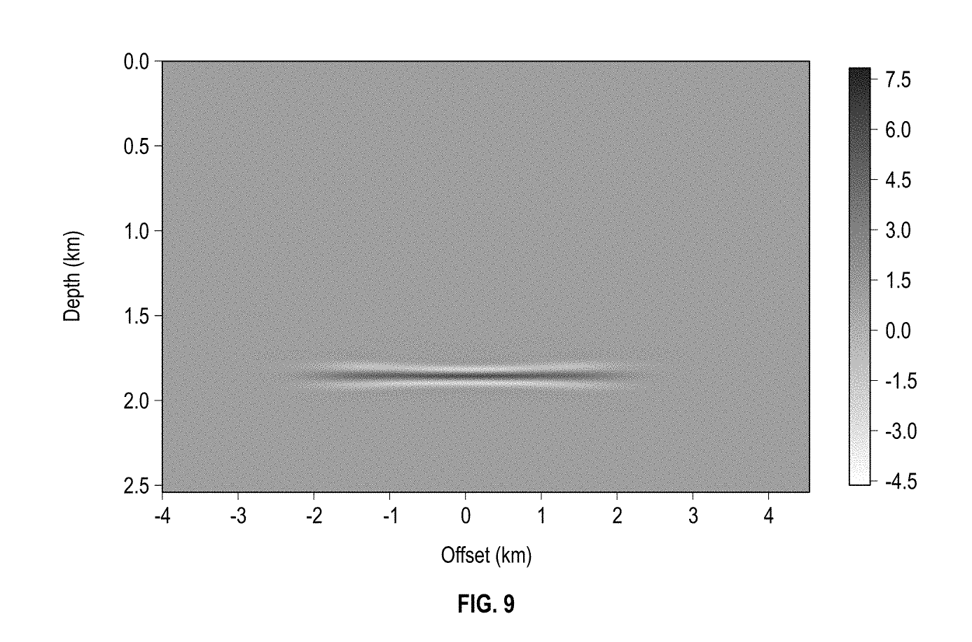

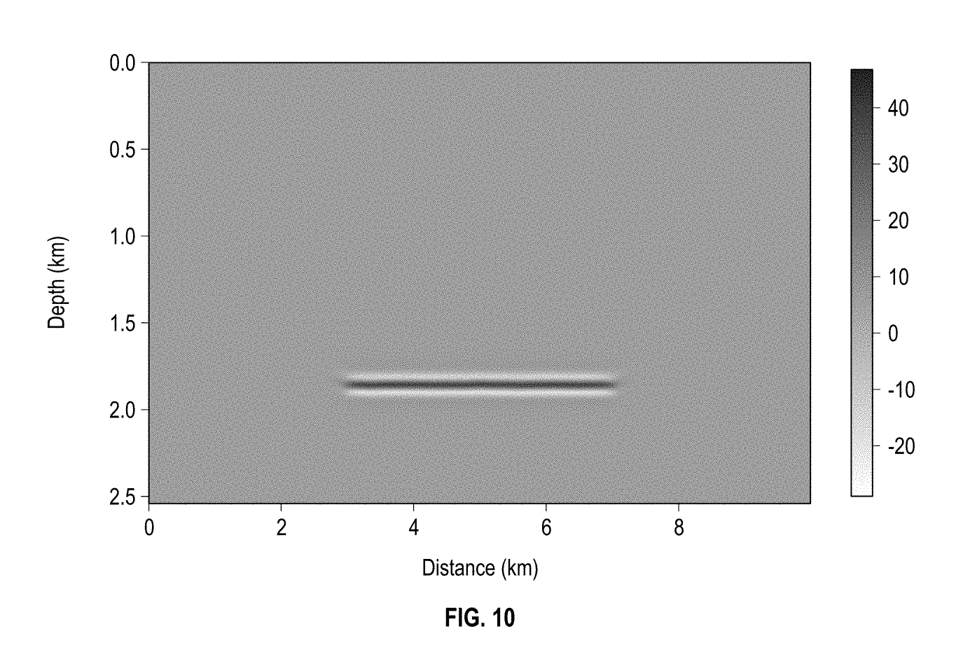

As a local inversion method is used, a starting shift array is required. In step 715, the input shift array is initialized to zero. Steps 720, 725 and 730 contain a loop over offsets starting from the zero-offset (or smallest positive offset) image. Once the shift array required to align the image associated with a given offset with the target image has been computed, that shift array is used to update the starting shift array to be used as the starting shift for the next offset. This strategy works well because shifts are generally small for near offsets and vary smoothly across offsets so this strategy can be used to mitigate cycle skipping issues with the alignment of far offsets by using an initial shift that is close to the correct shift. Once shifts for all positive offsets have been computed, the initial shift array is reinitialized in step 735, before starting a loop over steps 740, 745 and 750, which is performed over negative offsets. Once shift arrays for all offsets have been computed then the vector offset shift gather can be returned in step 755. Typically this will involve writing the vector offset shift gather to a digital storage device such as a hard disk but could involve keeping the data in memory for a subsequent routine. FIG. 8 shows the vector offset shift gathers for the center point in the model (x=5000 m). When these shifts are applied to the VOG, the resulting flat VOG are seen in FIG. 9. Stacking the flat VOG from FIG. 9 results in an improved stack seen in FIG. 10.

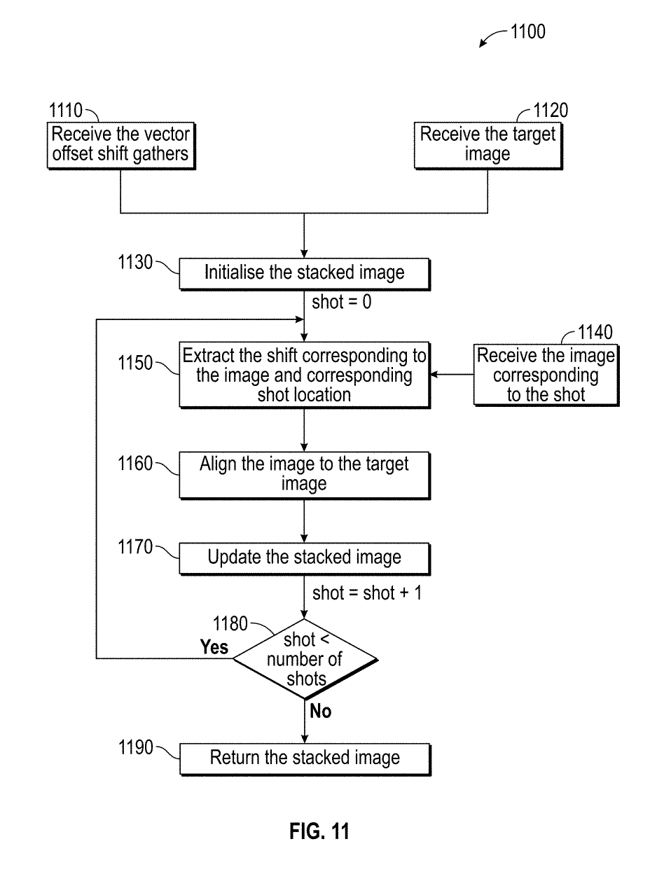

In step 260, the individual shot images are focused using the vector offset shift gathers that were computed in step 250 and the individual shot images from step 230. In this embodiment the shot focusing is performed using workflow 1100 in FIG. 11. In step 1110, the vector offset shift gathers are received (computed in workflow 700). The target image is provided in step 1120; in this embodiment the stack of the aligned VOG was provided (FIG. 10). In step 1130, the stack image is initialized; in this embodiment this involves defining an array of floats in memory with the same size as the target image and setting all values within the array to zero. Steps 1140-1180 comprise a loop over all the shots that were migrated in step 230. For each shot the image corresponding to that shot is provided in step 1140. In step 1150 the shift corresponding to the shot image is extracted from the vector offset shift gathers using equation 1 to compute the vector offset for each location in the image and then extracting the shift from the vector offset shift gathers using a linear interpolation. This shift is then used as an initial shift in step 1160 for the computation of a shift to align the shot image to the target image using the same approach as used for aligning the VOG in steps 720 and 740. In this case rather than returning the shift, the aligned shot image is passed to step 1170 (that is the shot image after the application of the shift). In step 1180 the stack is updated; all values in the stack array corresponded to positions in the aligned shot image are incremented by the value in the aligned shot image so the final stacked image will be the sum of all aligned shot images. Step 1180 is a simple inequality so that the loop is continued until all the shots have been aligned and stacked. The final stacked image of the aligned shot gathers is then returned in step 1190. In this embodiment this involves writing the stacked image to a hard disk so that it can be read by a seismic interpretation and visualization package for analysis and interpretation e.g. for reservoir interpretation and well planning.

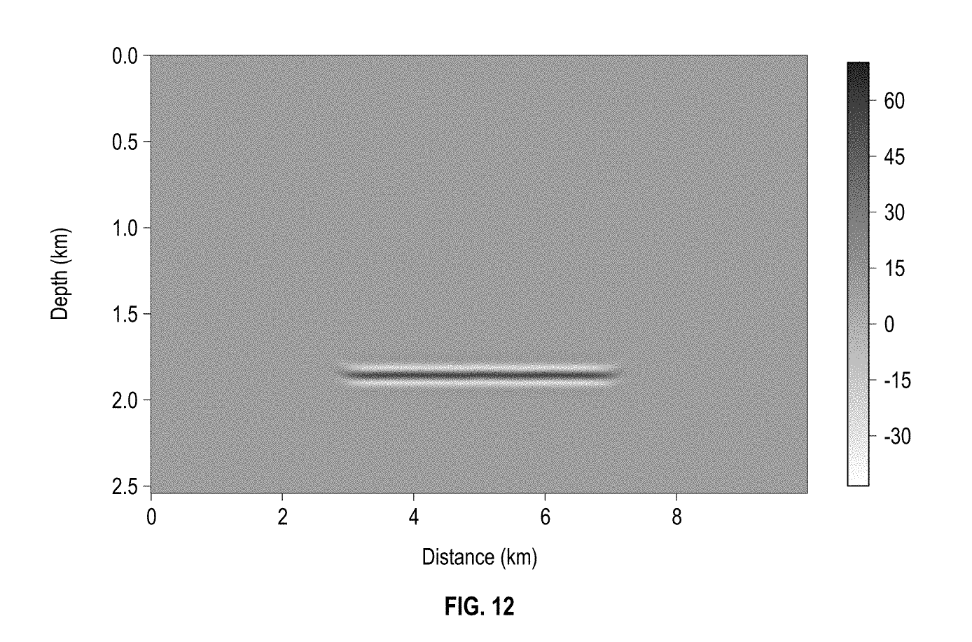

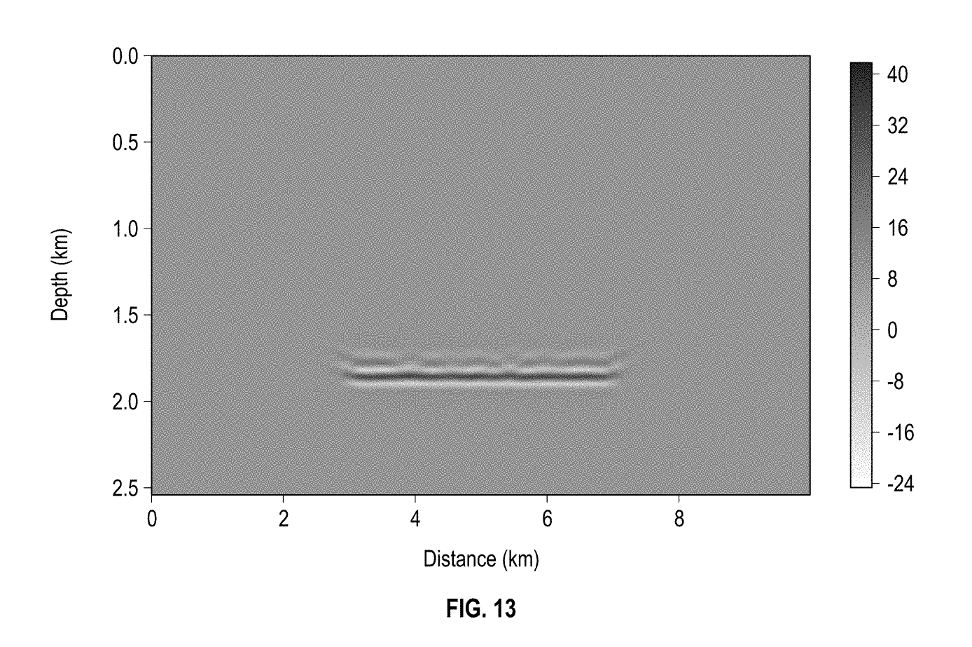

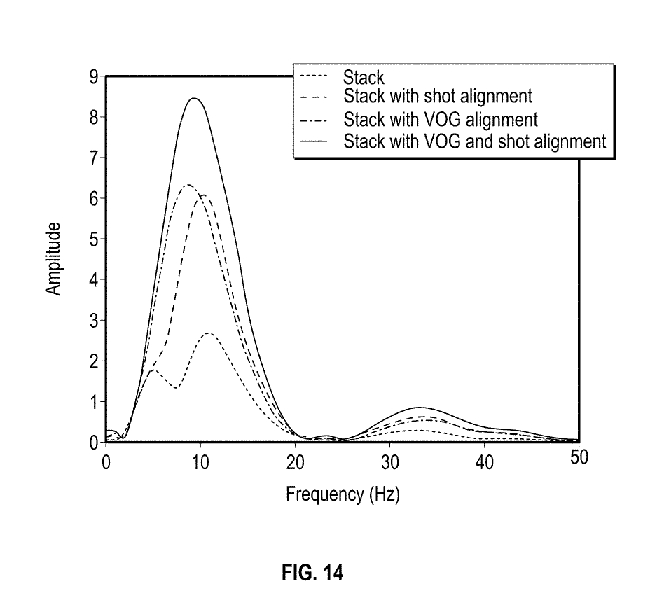

Applying the complete workflow to the simple example previously discussed, the stacked image in FIG. 12 is generated. The image in FIG. 12 has a higher peak amplitude and the wavelet is more compacted than in FIG. 5 or 10, allowing a more precise interpretation of geological features (for example the interpretation of smaller faults) and greater accuracy of amplitude based attributes. FIG. 13 is provided for comparison and was generated by applying workflow 1100; in the case where the initial shifts are set to zero, the target image was the brute stack image. FIG. 14 shows the spectrum of these four different images. The improvement of all three focusing methods over a brute stack (FIG. 5) is clear; the VOG focusing seems to improve the low frequencies (FIG. 10); the shot focusing seems to improves the high frequencies (FIG. 13); this embodiment using both VOG focusing and shot focusing improves over the other methods across the bandwidth of the data (FIG. 12).

Optionally, during the flow 200, the steps 250 and/or 260 and/or 270 could be performed iteratively to further improve the model by using an improved target image. Those skilled in the art would appreciate that other strategies for improving the image could also be used such as incorporating non-linear stacking (e.g. Liu et al (2009)). The iterations could be continued until convergence or some other criteria such as a user specified number of iterations. Other embodiments could use alternate migration approaches such as using one-way wave extrapolation methods (e.g. Ristow et al, 1994).

The workflow 200, is meant to be implemented on a computational system. The system 1500 in image 15, shows an exemplary computational system for aligning images to generate improved seismic images. The system contains a means for mass storage, 1510, on which the seismic data is stored and a means for processing the data, 1520. Typically there will also be a means for displaying and interpreting the resulting image, 1530, or alternatively plotting the result in some manner to enable the user to come to a better understanding of the sub-surface in the area of interest. The system 1500 maybe a single workstation but more typically would be a network of computers. The network may be a Local Area Network (LAN) or maybe distributed globally (for instance a combination of a local network and cloud computational resources).

For a small seismic dataset the storage system, 1510, maybe just a single hard disk. For a larger dataset, it would likely to be stored on multiple disks, such as a Redundant Array of Independent Disks (RAID). The seismic data is loaded, possibly by means of a portable storage device, for instance a collection of magnetic tapes or Digital Versatile Disks (DVDs), or via a network connection, such as by use of File Transfer Protocol (FTP) over a network, such as the internet.

The means for processing the data, 1520, will typically include one or more computer processor such as Central Processing Unit (CPU) and/or Graphical Processing Unit (GPU) or similar device and associated components such as memory and networking capabilities in a workstation or node. As mentioned, means for processing the data maybe a single node or many connected nodes. Workflow 200 will be formulated as an algorithm to be run on the computational device consisting of 1510 and 1520. The resulting image will be interpreted, for instance by transfer to a workstation with a connected display and a software package for the interpretation of seismic data. The resulting image and interpretation can then be used for such things as well planning.

The computational system 1500 may be implemented in hardware in conventional fashion. One skilled in the art will appreciate there are many different approaches to setting up the hardware and there are many complex subsystems to such a computational device. These computational devices are conventional and standard to seismic processing so the details will not be discussed in detail to save from distracting from the specifics discussed herein.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

### NON-PATENT REFERENCES

Albertin, U. & Zhang, L., 2014. Migration optimization through local phase alignment of partial migration images. In SEG Technical Program Expanded Abstracts. pp. 3769-3773.
Baysal, E. et. al., Reverse Time Migration, Geophysics, Vol. 48, No. 11 (November 1983) pp 1514-1524
Dablain M. A., The application of high-order differencing to the scalar wave-equation, Geophysics, Vol. 51, No. 1 (January 1986), pp 54-66
Dix, C. H., 1955. Seismic Velocities From Surface Measurements. Geophysics, 20(1), pp. 68-86.
Etgen, J. T., Gray, S. H. & Zhang, Y., 2009. An overview of depth imaging in exploration geophysics. Geophysics, 74(6), pp. WCA5-WCA17.
Etgen, J. T. et al., 2014. Adaptive image focusing. SEG Technical Program Expanded Abstracts, (4), pp. 3774-3778.
Farmer, P., Zhou, Z. & Jones, D., 2009. The role of reverse time migration in imaging and model estimation. The Leading Edge, 28(4), pp. 436-441.
Fomel, S. & Claerbout, J. F., 2003. Multidimensional recursive filter preconditioning in geophysical estimation problems. Geophysics, 68(2), p. 1-12.
Hinkley, D., Bear, G. W. & Dawson, C., 2004. Prestack gather flattening for AVO. In SEG Technical Program Expanded Abstracts. pp. 271-273.
Howie, J. et al., 2008. Unlocking the full potential of Atlantis with OBS nodes. In SEG Technical Program Expanded Abstracts. pp. 363-367.
Jiao, K. et al., 2014. Migration imaging enhancement through optimized alignment of vector image partitions. In SEG Technical Program Expanded Abstracts. pp. 3699-3703.
Jones, I. F., 2010. Tutorial: Velocity estimation via ray-based tomography. First Break, 28(February), pp. 45-52.
Liu, G. et al., 2009. Stacking seismic data using local correlation. Geophysics, 74(3), pp. V43-V48.
Liu, Y. & Sen, M. K., 2010. A hybrid scheme for absorbing edge reflections in numerical modeling of wave propagation. Geophysics, 75(2), pp. A1-A6.
McMechan, G. A., 1983. Migration by extrapolation of time-dependent boundary values. Geophysical Prospecting, 31, pp. 413-420.
Morton, S. et al., 2008. Optimizing the grouping of shots for shot-record migration. In SEG Technical Program Expanded Abstracts. pp. 2231-2235.
Press, W. et al., 1987. Numerical Recipes: The Art of Scientific Computing, Cambridge University Press
Ristow, D. & Rühl, T., 1994. Fourier finite-difference migration. Geophysics, 59(12), pp. 1882-1893.
Rothman, D. H., 1986. Automatic estimation of large residual statics corrections. Geophysics, 51(2), pp. 332-346.
Symes, W. W., 2008. Migration velocity analysis and waveform inversion. Geophysical Prospecting, 56, pp. 765-790.
Whitmore, N. D., 1983. Iterative Depth Migration by Backward Time Propagation. In SEG Technical Program Expanded Abstracts. pp. 382-385.
Wong, M., Biondi, B. L. & Ronen, S., 2015. Imaging with primaries and free-surface multiples by joint least-squares reverse time migration. Geophysics, 80(6), pp. S223-S235.
Yilmaz, O., 2001. Seismic Data Analysis: Processing, Inversion and Interpretation of Seismic Data 2nd ed., Society Of Exploration Geophysicists.

What is claimed is:

1. A method for seismic imaging, comprising:
a. selecting an input seismic dataset that samples a subsurface region of interest,
b. migrating said seismic dataset to generate a set of partial images using a processor,
c. generating a set of aligned partial images by focusing said partial images using shifts generated on Vector Offset Gathers as an intermediate step,
d. stacking said partial images to generate an improved image of the subsurface,
whereby an improved understanding of said subsurface region of interest is achieved.

2. The method of claim 1 wherein said partial images are the migration output of a single seismic source array and a plurality of seismic receivers.

3. The method of claim 1 wherein said migrating is performed using a numerical approximation to the two way wave equation.

4. The method of claim 1 wherein said migrating is performed using wave extrapolation in depth.

5. The method of claim 1 wherein said shifts are computed on time-shift gathers.

6. The method of claim 1 wherein said shifts are vertical spatial shifts.

7. The method of claim 1 wherein said shifts are spatial shifts perpendicular to the image dip.

8. The method of claim 1 wherein said stacking also includes a weighting step.

9. The method of claim 1 wherein said alignment is performed iteratively using the improved output image as an updated target image for the alignment process.

10. A computational system comprising of one or more processors and a set of instructions that when executed will perform the following:
a. loading an input seismic dataset that samples a subsurface region of interest,
b. migrating said seismic dataset to generate a set of partial images using a processor,
c. generating a set of aligned partial images by focusing said partial images using shifts generated on Vector Offset Gathers as an intermediate step,
d. stacking said partial images to generate an improved image of the subsurface,
whereby an improved understanding of said subsurface region of interest is achieved.

11. The system of claim 10 wherein said partial images are the migration output of a single seismic source array and a plurality of seismic receivers.

12. The system of claim 10 wherein said migrating is performed using a numerical approximation to the two way wave equation.

13. The system of claim 10 wherein said migrating is performed using wave extrapolation in depth.

14. The system of claim 10 wherein said shifts are computed on time-shift gathers.

15. The system of claim 10 wherein said shifts are vertical spatial shifts.

16. The system of claim 10 wherein said shifts are spatial shifts perpendicular to the image dip.

17. The system of claim 10 wherein said stacking also includes a weighting step.

18. The system of claim 10 wherein said alignment is performed iteratively using the improved output image as an updated target image for the alignment process.
